(19) United States
(12) Patent Application Publication
(10) Pub. No.: US 2019/0090252 A1
(43) Pub. Date: Mar. 21, 2019

(54) METHOD AND APPARATUS FOR REUSING P2P CONNECTION IN WIRELESS COMMUNICATION SYSTEM

(71) Applicant: LG ELECTRONICS INC., Seoul (KR)

(72) Inventors: Giwon Park, Seoul (KR); Byungjoo Lee, Seoul (KR)

(21) Appl. No.: 15/901,695

(22) Filed: Feb. 21, 2018

Related U.S. Application Data
(60) Provisional application No. 62/561,177, filed on Sep. 20, 2017.

(51) Int. Cl. H04W 72/08; H04L 29/08; H04B 17/318; H04B 17/336; H04W 72/00

(52) U.S. Cl. CPC H04W 72/085; H04L 67/104; H04W 84/12; H04B 17/336; H04W 72/005; H04B 17/318

(57) ABSTRACT

A method for allowing a terminal to reuse 60 GHz P2P (Peer to Peer) connection in a wireless communication system is disclosed. The method for reusing the 60 GHz P2P (Peer to Peer) connection by the terminal includes performing first Wi-Fi Display (WFD) session connection based on a Real Time Streaming Protocol (RTSP) message, completing the first WFD session connection, and performing second WFD session connection. The RTSP message includes a first parameter for indicating whether the 60 GHz P2P connection will be retained after completion of the first WFD session connection, and a second parameter for indicating whether the 60 GHz P2P connection will be reused after completion of the first WFD session connection. When the first parameter indicates that the 60 GHz P2P connection is not retained and the second parameter indicates that the 60 GHz P2P connection is reused, information associated with the 60 GHz P2P connection is exchanged when the first WFD session connection is completed.

This application claims the benefit of U.S. Provisional Application No. 62/561,177, filed on Sep. 20, 2017, which is hereby incorporated by reference as if fully set forth herein.

### BACKGROUND OF THE INVENTION

### Field of the Invention

The present invention relates to a wireless communication system, and more particularly to a method and apparatus for reusing P2P (Peer To Peer) connection in a wireless communication system.

### Discussion of the Related Art

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

Recently, various wireless communication technologies have been developed with the advancement of information communication technology. Among the wireless communication technologies, a wireless local area network (WLAN) is the technology capable of accessing the Internet by wireless in a home, a company or a specific service provided area through portable device such as a personal digital assistant (PDA), a laptop computer, a portable multimedia player (PMP), etc. based on a radio frequency technology.

A standard for a WLAN (wireless local area network) technology is developing by IEEE (institute of electrical and electronics engineers) 802.11 group. IEEE 802.11a and b use an unlicensed band on 2.4 GHz or 5 GHz, IEEE 802.11b provides transmission speed of 11 Mbps and IEEE 802.11a provides transmission speed of 54 Mbps. IEEE 802.11g provides transmission speed of 54 Mbps by applying OFDM (orthogonal frequency division multiplexing) on 2.4 GHz. IEEE 802.11n provides transmission speed of 300 Mbps by applying MIMO-OFDM (multiple input multiple output-orthogonal frequency division multiplexing). IEEE 802.11n supports a channel bandwidth up to 40 MHz. In this case, transmission speed can be provided as fast as 600 Mbps. IEEE 802.11p corresponds to a standard for supporting WAVE (wireless access in vehicular environments). For instance, 802.11p provides improvement necessary for supporting ITS (intelligent transportation systems). IEEE 802.11ai corresponds to a standard for supporting fast initial link setup of IEEE 802.11 station.

A DLS (direct link setup)-related protocol in wireless LAN environment according to IEEE 802.11e is used on the premise of a QBSS (quality BSS) supporting QoS (quality of service) supported by a BSS (basic service set). In the QBSS, not only a non-AP STA but also an AP corresponds to a QAP (quality AP) supporting QoS. Yet, in current commercialized wireless LAN environment (e.g., wireless LAN environment according to IEEE 802.11a/b/g etc.), although a non-AP STA corresponds to a QSTA (quality STA) supporting QoS, most of APs corresponds to a legacy AP incapable of supporting QoS. Consequently, in the current commercialized wireless LAN environment, there is a limit in that a QSTA is unable to use a DLS service.

In a recent situation that such a wireless short-range communication technology as Wi-Fi and the like is widely applied to a market, connection between devices is performed not only based on a local network but also based on direct connection between devices. One of technologies enabling devices to be directly connected is Wi-Fi Direct.

Wi-Fi Direct corresponds to a network connectivity standard technology describing up to operations of a link layer. Since there is no definition on a regulation or a standard for an application of a higher layer, it is difficult to have compatibility and consistency of an operation after Wi-Fi Direct devices are connected with each other. For this reason, such a standard technology including higher layer application technology as WFDS (Wi-Fi Direct service) is under discussion by WFA (Wi-Fi alliance).

The WFA has announced such a new standard for delivering data via a direct connection between mobile devices as Wi-Fi Direct. Hence, related industries are actively developing a technology for satisfying the Wi-Fi Direct standard. In a strict sense, the Wi-Fi Direct is a marketing terminology and corresponds to a brand name. A technology standard for the Wi-Fi Direct is commonly called Wi-Fi P2P (peer to peer). Hence, the present invention describing Wi-Fi-based P2P technology may be able to use Wi-Fi Direct and Wi-Fi P2P without any distinction. In a legacy Wi-Fi network, a user accesses the legacy Wi-Fi network via an AP (access point) and accesses the Internet to use a device on which Wi-Fi is mounted. A data communication method via direct connection between devices is also used in a legacy communication by some users in a manner of being mounted on a device (e.g., a cellular phone, a note PC, etc.) on which a wireless communication technology such as Bluetooth is mounted. Yet, according to the data communication method, transmission speed is slow and transmission distance is limited to within 10 m. In particular, when the data communication method is used for transmitting massive data or is used in environment at which many Bluetooth devices exist, there exists a technical limit in performance capable of being felt by a user.

Meanwhile, Wi-Fi P2P maintains most of functions of the legacy Wi-Fi standard and includes an additional part for supporting direct communication between devices. Hence, the Wi-Fi P2P can sufficiently utilize hardware and physical characteristics of a device on which a Wi-Fi chip is mounted and is able to provide device-to-device P2P communication by upgrading a software function only.

As widely known, the device on which the Wi-Fi chip is mounted is extending to various ranges including a note PC, a smartphone, a smart TV, a game console, a camera and the like. For the device, sufficient numbers of suppliers and technology development personnel have been formed.

In recent times, standards of a method for using a 60 GHz band in a wireless LAN (WLAN) environment based on IEEE 802.11ay have been defined.

### SUMMARY OF THE INVENTION

Accordingly, the present invention is directed to a method and apparatus for reusing P2P connection in a wireless communication system.

An object of the present invention is to provide a method for providing a method for reusing P2P connection in a wireless communication system.

Another object of the present invention is to provide a method for reusing P2P connection based on 60 GHz in a wireless communication system.

Another object of the present invention is to provide a method for exchanging information needed for P2P connection in consideration of 60 GHz frequency characteristics.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reusing 60 GHz P2P (Peer to Peer) connection by a terminal in a wireless communication system, comprising: performing first Wi-Fi Display (WFD) session connection based on a Real Time Streaming Protocol (RTSP) message; completing the first WFD session connection; and performing second WFD session connection, wherein the RTSP message includes a first parameter for indicating whether the 60 GHz P2P connection will be retained after completion of the first WFD session connection, and a second parameter for indicating whether the 60 GHz P2P connection will be reused after completion of the first WFD session connection, and if the first parameter indicates that the 60 GHz P2P connection is not retained and the second parameter indicates that the 60 GHz P2P connection is reused, information associated with the 60 GHz P2P connection is exchanged when the first WFD session connection is completed.

In accordance with another aspect of the present invention, a terminal for reusing 60 GHz P2P (Peer to Peer) connection in a wireless communication system, comprising: a receiver configured to receive information from an external terminal; a transmitter configured to transmit information to the external terminal; and a processor configured to control the receiver and the transmitter, wherein the processor performs first Wi-Fi Display (WFD) session connection based on a Real Time Streaming Protocol (RTSP) message, completes the first WFD session connection, and performs second WFD session connection, wherein the RTSP message includes a first parameter for indicating whether the 60 GHz P2P connection will be retained after completion of the first WFD session connection, and a second parameter for indicating whether the 60 GHz P2P connection will be reused after completion of the first WFD session connection, and if the first parameter indicates that the 60 GHz P2P connection is not retained and the second parameter indicates that the 60 GHz P2P connection is reused, information associated with the 60 GHz P2P connection is exchanged when the first WFD session connection is completed.

The information associated with the 60 GHz P2P connection may include 60 GHz beamforming control information, and the 60 GHz beamforming control information may include best sector ID (identifier) information.

The best sector ID information may indicate a sector having the highest SNR (Signal Noise Ratio) or the highest RSSI (Received Signal Strength Indicator) from among a plurality of sectors established at 60 GHz.

The first WFD session connection may be completed based on an M8 request message and an M8 response message, and the 60 GHz P2P connection associated information may be contained in the M8 request message and the M8 response message, and is then exchanged.

The 60 GHz P2P connection associated information may be cached to the terminal, before the first WFD session connection is completed.

The method further comprising, after completion of the first WFD session connection, exchanging the 60 GHz P2P connection associated information prior to completion of the 60 GHz P2P connection.

When the first parameter indicates that the 60 GHz P2P connection is retained, the second parameter may be set to a null value.

The first parameter may be included in at least one of an M3 request message, an M4 request message, and an M5 request message.

The second parameter may be included in at least one of an M3 request message, an M4 request message, and an M5 request message.

the first parameter may be a ‘wfd_persistent_connect’ parameter, and the second parameter may be a “wfd_persistent_reuse’ parameter.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a structure of an IEEE 802.11 system to which the present invention can be applied.

FIG. 2 is a block diagram illustrating an exemplary operation of a communication system employing access devices and wireless devices.

FIG. 3 illustrates a Wi-Fi Direct (WFD) network.

FIG. 4 illustrates a process of constructing a WFD network

FIG. 5 illustrates a typical P2P network topology.

FIG. 6 illustrates a situation in which one P2P device forms a P2P group and, simultaneously, operates as an STA of a WLAN to be connected to an AP.

FIG. 7 illustrates a WFD network state when P2P is applied thereto.

FIG. 8 is a schematic block diagram of a Wi-Fi Direct Services (WFDS) device.

FIG. 9 illustrates a process of performing device discovery and service discovery between WFDS devices to connect a WFDS session in conventional WFDS.

FIG. 10 illustrates a service application platform supporting multiple interfaces.

FIG. 11 is a structural view illustrating a data and control plane for use in a WFD device.

FIG. 12 is a conceptual diagram illustrating a method for exchanging a Real Time Streaming Protocol (RTSP) message.

FIG. 13 is a conceptual diagram illustrating a method for performing a Sector Level Sweep (SLS).

FIG. 14 is a conceptual diagram illustrating a method for reusing P2P connection through a P2P interface.

FIG. 15 is a conceptual diagram illustrating a method for reusing P2P connection through a P2P interface.

FIG. 16 is a conceptual diagram illustrating a method for reusing P2P connection through a P2P interface.

FIG. 17 is a conceptual diagram illustrating a method for reusing P2P connection through a P2P interface.

FIG. 18 is a conceptual diagram illustrating a method for reusing P2P connection through a Wi-Fi infrastructure interface.

FIG. 19 is a conceptual diagram illustrating a method for reusing P2P connection through a P2P interface.

FIG. 20 is a block diagram illustrating a device according to an embodiment of the present invention.

### DESCRIPTION OF SPECIFIC EMBODIMENTS

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide the full understanding of the present invention. However, it will be apparent to those skilled in the art that the present invention may be implemented without such specific details.

The following embodiments can be achieved by combinations of structural elements and features of the present invention in prescribed forms. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies in the following description are provided to help the understanding of the present invention. And, these specific terminologies may be changed to other formats within the technical scope or spirit of the present invention.

Occasionally, to avoid obscuring the concept of the present invention, structures and/or devices known to the public may be skipped or represented as block diagrams centering on the core functions of the structures and/or devices. In addition, the same reference numbers will be used throughout the drawings to refer to the same or like parts in this specification.

The embodiments of the present invention can be supported by the disclosed standard documents disclosed for at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document can be supported by the above standard documents.

The following embodiments of the present invention can be applied to a variety of wireless access technologies, for example, CDMA (code division multiple access), FDMA (frequency division multiple access), TDMA (time division multiple access), FDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

In the specification, when a part “comprises” or “includes” an element, it means that the part further comprises or includes another element unless otherwise mentioned. Also, the terms “ . . . unit”, “ . . . module” disclosed in the specification means a unit for processing at least one function or operation, and may be implemented by hardware, software or combination of hardware and software.

For clarity, the following description focuses on IEEE 802.11 systems. However, technical features of the present invention are not limited thereto.

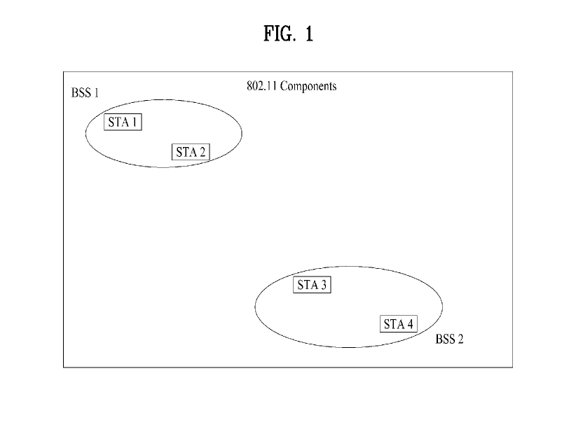

FIG. 1 is a diagram for an example of a structure of IEEE 802.11 system to which the present invention is applicable.

IEEE 802.11 structure can consist of a plurality of configuration elements and a WLAN supporting mobility of an STA, which is transparent to an upper layer, can be provided by interaction of a plurality of the configuration elements. A basic service set (hereinafter abbreviated BSS) may correspond to a basic configuration block in IEEE 802.11 LAN. FIG. 1 shows an example that there exist two BSSs (BSS 1 and BSS 2) and two STAs are included in each of the BSSs as members, respectively (STA 1 and STA 2 are included in the BSS 1 and STA 3 and STA 4 are included in the BSS 2). In this case, an STA indicates a device operating according to MAC (medium access control)/PHY (physical) standard of IEEE 802.11. An STA includes an AP (access point) STA (simply, an AP) and a non-AP STA. An AP corresponds to a device providing network access (e.g., WLAN) to a non-AP STA via a wireless interface. The AP can be configured by a fixed form or a mobile form and includes a mobile wireless device (e.g., a laptop computer, a smartphone, etc.) providing a hot-spot. The AP corresponds to a base station (BS), a Node-B, an evolved Node-B (eNB), a base transceiver system (BTS), a femto BS and the like in a different wireless communication field. The non-AP STA corresponds to a device directly controlled by a user such as a laptop computer, a PDA, a wireless modem, a smartphone and the like. The non-AP STA can be called a device, a wireless transmit/receive unit (WTRU), a user equipment (UE), a mobile station (MS), a mobile device, a mobile subscriber station (MSS), and the like.

An oval indicating a BSS in FIG. 1 may be comprehended as a coverage area of the STAs included in the BSS to maintain a communication. This area can be called a basic service area (hereinafter abbreviated BSA). A BSS of a most basic type in IEEE 802.11 LAN may correspond to an independent BSS (hereinafter abbreviated IBSS). For instance, the IBSS may have a minimum form consisting of two STAs only. The BSS (BSS 1 or BSS 2), which is the simplest form and omitted different configuration elements, in FIG. 1 may correspond to a representative example of the IBSS. This sort of configuration is available when the STAs are able to directly communicate with each other. And, this kind of LAN can be configured when a LAN is necessary instead of being configured in advance. Hence, this network may be called an ad-hoc network.

When power of an STA is turned on or turned off or an STA enters into a BSS area or gets out of the BSS area, a membership of the STA in a BSS can be dynamically changed. In order to be a member of the BSS, the STA can join the BSS using a synchronization process. In order to access all services based on a BSS structure, the STA can be associated with the BSS.

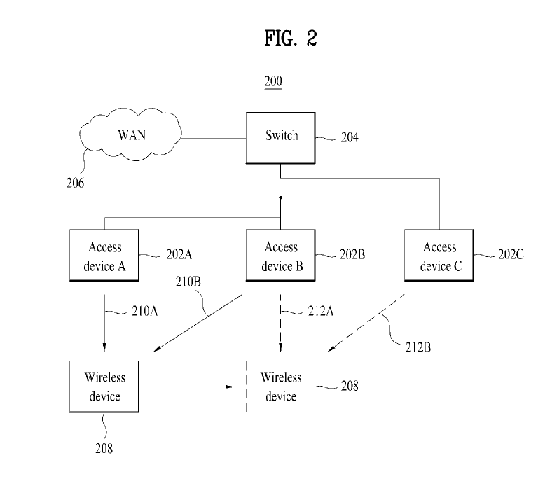

FIG. 2 is a block diagram for an example of a communication system 200 adopting access devices (e.g., AP STAs) 220A/202B/202C and wireless user devices (e.g., non-AP STAs).

Referring to FIG. 2, access devices 202A to 202C are connected with a switch 204 providing access to a WAN (wide area network) 206 such as the Internet. Each of the access devices 202A to 202C provides wireless access to wireless devices belonging to a coverage area (not depicted) of the access device via a time division multiplexed network. Hence, the access devices 202A to 202C commonly provide a total WLAN coverage area of the system 200. For instance, a wireless device 208 may exist in a coverage area of the access devices 202A and 202B in a position represented by a box of a line. Hence, the wireless device 208 can receive beacons from each of the access devices 202A/202B as shown by line arrows 210A and 210B. If the wireless device 208 roams to a dotted line box from the line box, the wireless device 208 enters a coverage area of the access device 202C and leaves a coverage area of the access device 202A. Hence, as shown by dotted lines 212A and 212B, the wireless device 208 can receive beacons from the access devices 202B/202C.

When the wireless device 208 roams in the total WLAN coverage area provided by the system 200, the wireless device 208 can determine which device provides best access to the wireless device 208. For instance, the wireless device 208 repeatedly scans beacons of adjacent access devices and may be able to measure signal strength (e.g., power) related to each of the beacons. Hence, the wireless device 208 can be connected with an access device providing optimal network access based on maximum beacon signal strength. The wireless device 208 may be able to use a different reference related to optimal access. For instance, the optimal access may be associated with more preferable services (e.g., contents, data rate and the like).

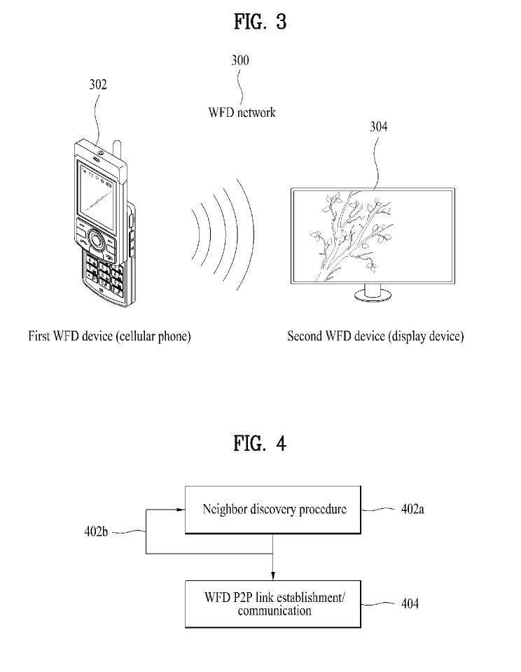

FIG. 3 is a diagram for an example of a WFD (Wi-Fi Direct) network.

A WFD network corresponds to a network capable of performing D2D (device-to-device) (or peer to peer (P2P) communication although Wi-Fi devices do not participate in a home network, an office network or a hot-spot network. The WFD network is proposed by Wi-Fi alliance. In the following, WFD-based communication is called WFD D2D communication (simply, D2D communication) or WFD P2P communication (simply, P2P communication). And, a device performing the WFD P2P communication is called a WFD P2P device, simply, a P2P device.

Referring to FIG. 3, a WFD network 300 can include at least one or more Wi-Fi devices including a first WFD device 302 and a second WFD device 304. A WFD device includes devices supporting Wi-Fi such as a display device, a printer, a digital camera, a projector, a smartphone and the like. And, the WFD device includes a non-AP STA and an AP STA. Referring to an example shown in the drawing, the first WFD device 302 corresponds to a smartphone and the second WFD device 304 corresponds to a display device. WFD devices in the WFD network can be directly connected with each other. Specifically, P2P communication may correspond to a case that a signal transmission path between two WFD devices is directly configured between the WFD devices without passing through a third device (e.g., an AP) or a legacy network (e.g., access WLAN via an AP). In this case, the signal transmission path directly configured between the two WFD devices may be restricted to a data transmission path. For instance, P2P communication may correspond to a case that a plurality of non-STAs transmit data (e.g., audio/image/text message information etc.) without passing through an AP. A signal transmission path for control information (e.g., resource allocation information for P2P configuration, wireless device identification information and the like) can be directly configured between WFD devices (e.g., between a non-AP STA and a non-AP STA, between a non-AP STA and an AP), between two WFD devices (e.g., between a non-AP STA and a non-AP STA) via an AP or between an AP and a corresponding WFD device (e.g., an AP and a non-AP STA #1, between an AP and a non-AP STA #2).

FIG. 4 is a flowchart for an example of a procedure of configuring a WFD network.

Referring to FIG. 4, a procedure of configuring a WFD network can be mainly divided into two procedures. A first procedure corresponds to a neighbor (device) discovery (ND) procedure [S402a] and a second procedure corresponds to a P2P link configuration and communication procedure [S404]. A WFD device (e.g., 302 in FIG. 3) finds out a different neighboring device (e.g., 304 in FIG. 3) in coverage (of the WFD device) via the neighbor discovery procedure and may be able to obtain information necessary for associating with the neighboring WFD device, e.g., information necessary for pre-association. In this case, the pre-association may indicate second layer pre-association in a wireless protocol. The information necessary for the pre-association can include identification information on the neighboring WFD device for example. The neighbor discovery procedure can be performed according to an available radio channel [S402b]. Subsequently, the WFD device 302 can perform a WFD P2P link configuration/communication procedure with the different WFD device 304. For instance, the WFD device 302 can determine whether the WFD device 304 corresponds to a WFD device not satisfying a service requirement of a user after the WFD device 302 is connected with the neighboring WFD device 304. To this end, the WFD device 302 is second layer pre-associated with the neighboring WFD device 304 and may be then able to search for the WFD device 304. If the WFD device 304 does not satisfy the service requirement of the user, the WFD device 302 disconnects the second layer connection established with the WFD device 304 and may be able to establish the second layer connection with a different WFD device. On the contrary, if the WFD device 304 satisfies the service requirement of the user, the two WFD devices 302/304 can transceive a signal with each other via a P2P link.

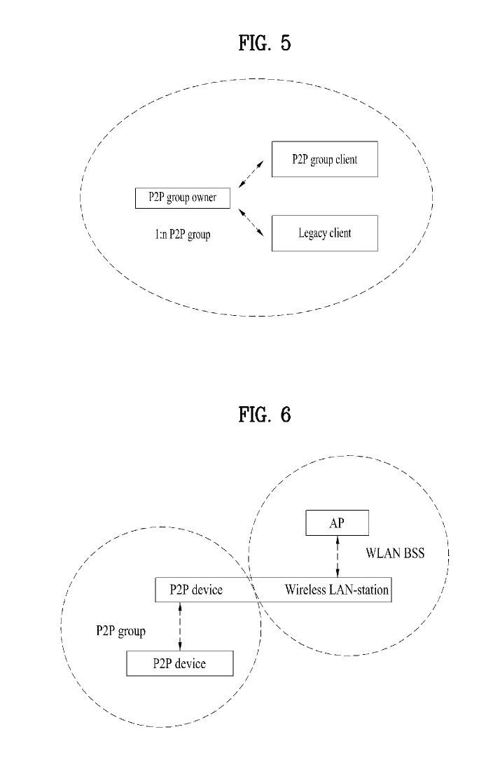

FIG. 5 is a diagram for a typical P2P network topology.

As shown in FIG. 5, a P2P GO can be directly connected with a client including a P2P function. Or, the P2P GO can be connected with a legacy client, which has no P2P function.

FIG. 6 is a diagram for a situation that a single P2P device forms a P2P group and is connected with an AP in a manner of operating as an STA of WLAN at the same time.

As shown in FIG. 6, according to P2P technical standard, a situation that a P2P device operates in the aforementioned mode is defined as a concurrent operation.

In order for a series of P2P devices to form a group, a P2P GO is determined based on a group owner intent value of a P2P attribute ID. The group owner intent value may have a value ranging from 0 to 15. P2P devices are exchanging the values and a P2P device including a highest value becomes the P2P GO. Meanwhile, in case of a legacy device not supporting the Wi-Fi P2P technology, although the legacy device can belong to a P2P group, a function of the legacy device is limited to a function of accessing an infrastructure network via the P2P GO.

According to Wi-Fi P2P standard, since a P2P GO transmits a beacon signal using OFDM (orthogonal frequency division multiplexing), a P2P device does not support 11b standard. Instead, 11a/g/n can be used as Wi-Fi P2P device.

In order to perform an operation of connecting a P2P GO and a P2P client with each other, a P2P standard mainly includes 4 functions described in the following.

First of all, P2P discovery is dealing with such a description entry as device discovery, service discovery, group formation and P2P invitation. According to the device discovery, 2 P2P devices exchange device-related information such as a device name of a counterpart device or a device type with each other via an identical channel According to the service discovery, a service to be used and service-related information are exchanged with each other via P2P. According to the group formation, it corresponds to a function that a device to be a P2P GO is determined and a new group is formed. According to the P2P invitation, it corresponds to a function that a permanently formed P2P group is summoned or a function of making a P2P device join a legacy P2P group.

Secondly, P2P group operation explains P2P group formation and termination, connection to a P2P group, communication in a P2P group, a service for P2P client discovery, operation of a persistent P2P group and the like.

Thirdly, P2P power management is dealing with a method of managing power of a P2P device and a method of processing a signal on power saving mode timing.

Lastly, managed P2P device is dealing with a method of forming a P2P group in a single P2P device and a method of accessing an infrastructure network via a WLAN AP at the same time.

Characteristics of a P2P group are explained in the following. A P2P group is similar to a legacy infrastructure BSS (basic service set) in that a P2P GO plays a role of an AP and a P2P client plays a role of an STA. Hence, software capable of performing a role of a GO and a role of a client should be mounted on a P2P device. The P2P device is distinguished by using a P2P device address such as a MAC address. Yet, when the P2P device performs communication in a P2P group, the P2P device uses a P2P interface address. In this case, it is not necessary for the P2P device to use a single identifier (a globally unique ID) address. The P2P group includes a single identifier P2P group ID. The single identifier P2P group ID consists of a combination of an SSID (service set identifier) and a P2P device address. Wi-Fi P2P standard uses WPA2-PSK/AES for security. A life cycle of a P2P group has a temporary connection method and a persistent connection method for attempting an identical connection after prescribed time. In case of a persistent group, once a P2P group is formed, a role, a certificate, an SSID and a P2P group ID are cached. When connection is reestablished, connection of a group can be promptly established by applying an identical connection form.

In the following, Wi-Fi P2P connection method is explained. A Wi-Fi device mainly performs a connection procedure of two phases. First one corresponds to a phase that two P2P devices find out a counterpart device and a second one corresponds to a group formation phase for determining a role of a P2P GO or a role of a P2P client between discovered devices. First of all, the finding phase corresponds to a phase of connecting P2P devices with each other. In particular, the finding phase includes a search state and a listen state. The search state performs active search using a probe request frame. In this case, a range of the search is restricted for a quick search. For the quick search, such a social channel as a channel 1, 6 and 11 are used. A P2P device of the listen state maintains a reception state in a manner of selecting one channel from the 3 social channels. If the P2P device receives a probe request frame transmitted by a different P2P device of the search state, the P2P device transmits a probe response frame to the different P2P device in response to the probe request frame. P2P devices continuously repeat the search state and the listen state and may be able to arrive at a channel common to the P2P devices. The P2P devices find out a counterpart device and use a probe request frame and a probe response frame to selectively combine with the counterpart device and to discover a device type, a manufacturer, or a friendly device name. In order to check a service existing in the internal of the P2P devices and compatible between the devices, it may use the service discovery. The service discovery is used to determine whether a service provided in the internal of each device is compatible with a different device. According to the P2P standard, a specific service discovery standard is not designated. A user of a P2P device searches for a neighboring P2P device and a service provided by the P2P device and may be then able to connect with a device or a service preferred by the user.

As a second phase, a group formation phase is explained in the following. If a P2P device completes the aforementioned find phase, checking existence of a counterpart device is completed. Based on this, two P2P devices should enter a GO negotiation phase to configure a BSS. The negotiation phase is divided into two sub phases. One is a GO negotiation phase and another is a WPS (Wi-Fi protected setup) phase. In the GO negotiation phase, the two P2P devices negotiate a role of a P2P GO and a role of a P2P client with each other and an operation channel to be used in the internal of a P2P group is configured. In the WPS phase, such a usual job performed in a legacy WPS as exchanging PIN information inputted by a user using a keypad or the like, simple setup via a push button and the like is performed. In a P2P group, a P2P GO plays core role of the P2P group. The P2P GO assigns a P2P interface address, selects an operation channel of the group and transmits a beacon signal including various operation parameters of the group. In the P2P group, a beacon signal can be transmitted by the P2P GO only. A P2P device can quickly check the P2P GO using the beacon signal in a scan phase corresponding to a connection initial phase and performs a role of participating in the group. Or, the P2P GO can initiate a P2P group session by itself or may be able to initiate a session after the method mentioned earlier in the P2P finding phase is performed. Hence, since a value intended to be the P2P GO is controlled by an application or a higher layer service instead of a value fixed by a certain device, a developer can select an appropriate value, which is intended to be the P2P GO, according to a usage of each application program.

Subsequently, P2P addressing is explained in the following. A P2P device uses a P2P interface address in a manner of assigning a P2P interface address using a MAC address in a P2P group session. In this case, the P2P interface address of a P2P GO corresponds to a BSSID (BSS identifier). The BSSID practically corresponds to a MAC address of the P2P GO.

Connection release of a P2P group is explained in the following. If a P2P session is terminated, a P2P GO should inform all P2P clients of termination of a P2P group session via De-authentication. A P2P client can also inform the P2P GO of connection release. In this case, if possible, it is necessary to perform a disassociation procedure. Having received a connection release request of a client, the P2P GO can identify that connection of the P2P client is released. If the P2P GO detects a P2P client making a protocol error or performing an operation of interrupting connection of a P2P group, the P2P GO generates rejection of authentication or a denial of association. In this case, the P2P GO records a concrete failure reason on an association response and transmits the association response to the P2P client.

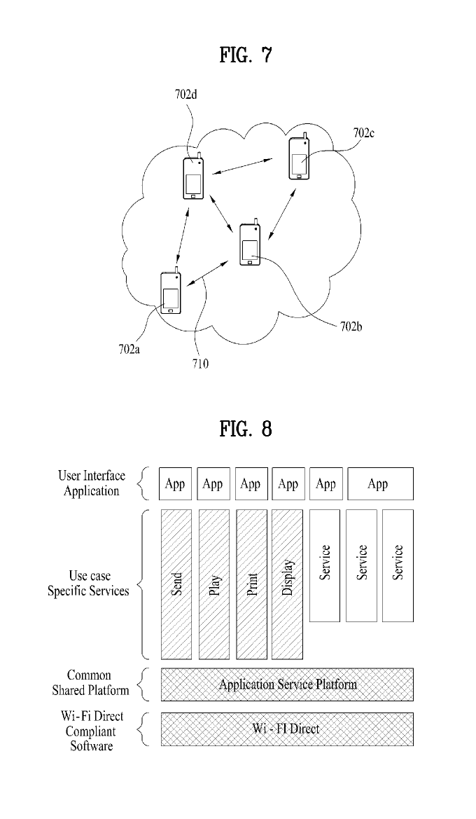

FIG. 7 is a diagram for a WFD network aspect in case that P2P is applied.

FIG. 7 shows an example of a WFD network aspect in case of applying a new P2P application (e.g., social chatting, location-based service provision, game interworking and the like). Referring to FIG. 7, a plurality of P2P devices 702a to 702d perform P2P communication 710 in a WFD network. P2P device(s) constructing the WFD network frequently change due to movement of the P2P device or the WFD network itself can be newly generated or disappeared dynamically/in a short time. Hence, characteristic of the new P2P application part is in that P2P communication can be performed and terminated dynamically/in a short time between a plurality of the P2P devices in dense network environment.

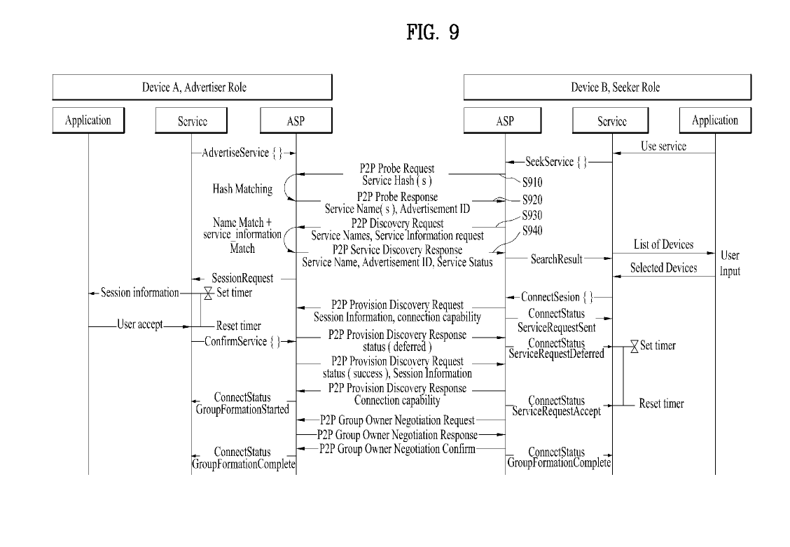

FIG. 8 is a simplified block diagram for a WFDS (Wi-Fi Direct services) device.

A platform for such an application service as an ASP (application service platform) is defined for a Wi-Fi Direct MAC layer and above. The ASP plays a role of session management, command processing of a service, control between ASPs and security between a higher application and a lower Wi-Fi Direct. 4 basic services including a Send service, a Play service, a Display service and a Print service defined by WFDS, a corresponding application and an UI (user interface) are supported at the top of the ASP. In this case, the Send service corresponds to a service capable of performing file transfer between two WFDS devices and an application therefor. The Play service corresponds to a streaming service capable of sharing A/V, a picture, and music based on a DLNA between two WFDS devices and an application therefor. The Print service defines a service capable of outputting a document and a picture between a device including contents such as a document, a picture and the like and a printer and an application therefor. The Display service defines a service enabling screen sharing between Miracast source of WFA and Miracast sink and an application therefor. And, an enablement service is defined for the use of an ASP common platform in case of supporting a third party application except a basic service.

Among terminologies described in the present invention, such a terminology as a service hash is formed from a service name using a first 6 octets of a service hash algorithm (e.g., SHA256 hashing) of a service name A service hash used by the present invention does not mean a specific service hash. Instead, it may be preferable to comprehend the service hash as a sufficient representation of a service name using a probe request/response discovery mechanism. As a simple example, if a service name corresponds to “org.wifi.example”, 6 bytes of a forepart of a value of which the service name is hashed by the SHA256 corresponds to a hash value.

In WFDS, if a hash value is included in a probe request message and a service is matched with each other, it may be able to check whether the service is supported in a manner of responding by a probe response message including a service name. In particular, the service name corresponds to a name of a user readable service of a DNS form. A service hash value indicates upper 6 bytes among a value of 256 bytes of the service name generated by an algorithm (e.g., SHA256). As mentioned in the foregoing example, if a service name corresponds to “org.wifi.example”, a service hash may correspond to a value of “4e-ce-7e-64-39-49”.

Hence, a part of a value of which a service name is hashed by an algorithm is represented as a service hash (information) in the present invention. The service hash can be included in a message as information.

Method of Configuring Legacy WFDS

FIG. 9 is a flowchart for a process of establishing a WFDS session by discovering a device and a service between WFDS devices in a legacy WI-DS.

For clarity, as shown in FIG. 4, assume that a device A plays a role of an advertiser advertising a WFDS capable of being provided by the device A to a seeker and a device B plays a role in seeking an advertised service. The device A corresponds to a device intending to advertise a service of the device A and a counterpart device intends to start the service in a manner of finding out the service of the device A. The device B performs a procedure of finding out a device supporting a service according to a request of a higher application or a user.

A service end of the device A advertises a WFDS capable of being provided by the service end to an application service platform (ASP) end of the device A. A service end of the device B can also advertise a WFDS capable of being provided by the service end to an ASP end of the device B. In order for the device B to use a WI-DS as a seeker, an application end of the device B indicates a service to be used to the service end and the service end indicates the ASP end to find out a target device to use the WFDS.

In order to find out the target device to use the WI-DS, the ASP end of the device B transmits a P2P (peer to peer) probe request message [S910]. In this case, the P2P probe request message includes a service name, which is intended to be found out by the ASP end of the device B or is capable of being supported by the ASP end of the device B, in a service hash form in a manner of hashing the service name Having received the P2P probe request message from the seeker, if the device A supports the corresponding service, the device A transmits a P2P probe response message to the device B in response to the P2P probe request message [S920]. The P2P probe response message includes a service supported by a service name or a hash value and a corresponding advertise ID value. This procedure corresponds to a device discovery procedure indicating that the device A and the device B are WFDS devices. It is able to know whether a service is supported via the device discovery procedure.

Subsequently, it is able to know a specific service in detail via a P2P service discovery procedure, optionally. The device B, which has found a device capable of performing a WFDS with the device B, transmits a P2P service discovery request message to the device [S930]. Having received the P2P service discovery request message from the device B, the ASP end of the device A transmits a P2P service discovery response message to the device B in a manner of matching the service advertised by the service end of the device A with a P2P service name and a P2P service information received from the device B with each other [S940]. In this case, a GAS protocol defined by IEEE 802.11u is used. As mentioned in the foregoing description, when a request for a service search is completed, the device B can inform an application and a user of a search result. At this point, a group of Wi-Fi Direct is not formed yet. If a user selects a service and the selected service performs a connect session, P2P group formation is performed.

Before the present invention is explained, it is necessary to be cautious of one thing. It is necessary to distinguish a legacy Wi-Fi Direct connection from Wi-Fi Direct service (WFDS) connection described in the present invention. According to the legacy Wi-Fi Direct, it mainly concerns up to a L2 layer, whereas the recently discussed WFDS connection concerns not only the L2 layer but also a higher layer of the L2 layer. In particular, the WFDS connection is dealing with a service session connection performed by an application service platform. Hence, the WI-DS connection may have more diversified and more complex cases compared to the legacy L2 layer connection and it is required to have definition on the cases. In addition, in case of connecting Wi-Fi Direct only between devices and in case of connecting Wi-Fi Direct service between devices, configuration and order of a control frame, which is exchanged via Wi-Fi, may become different.

In this case, for example, among the aforementioned interfaces, the BLE may correspond to a Bluetooth transmission/reception scheme in a form of using a frequency of 2.4 GHz and reducing power consumption. In particular, in order to quickly transmit and receive data of extremely small capacity, it may use the BLE to transmit data while reducing power consumption.

And, for example, the NAN (neighbor awareness networking) network may correspond to NAN devices using a set of the same NAN parameters (e.g., a time period between continuous discovery windows, a period of a discovery window, a beacon interval, a NAN channel, etc.). The NAN devices can configure a NAN cluster. In this case, the NAN cluster uses a set of the same NAN parameters and may correspond to a set of NAN devices synchronized with the same window schedule. A NAN device belonging to the NAN cluster can directly transmit a multicast/unicast NAN service discovery frame to a different NAN device within a range of a discovery window.

And, for example, the NFC may operate on a relatively low frequency band such as 13.56 MHz. In this case, if two P2P devices support the NFC, it may optionally use an NFC channel A seeker P2P device can discover a P2P device using the NFC channel. When an NFC device is discovered, it may indicate that two P2P devices agree on a common channel for forming a group and share provisioning information such as a password of a device.

A method of interworking via an ASP for the aforementioned interfaces is explained in detail in the following. In this case, although the abovementioned configurations are proposed as an interface capable of being interlocked with the ASP, this is an example only. It may support a different interface as well, by which the present invention may be non-limited.

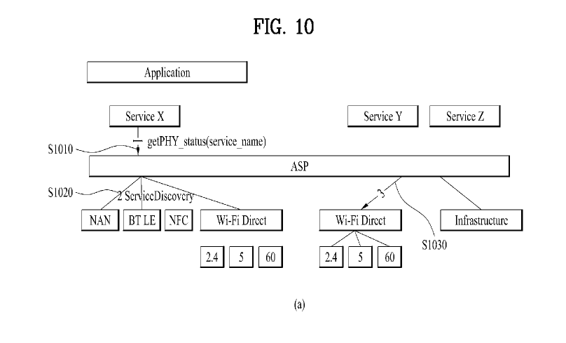

FIG. 10 illustrates an application service platform (ASP) supporting multiple interfaces.

As described above, a service end of an advertiser device as a device supporting WFDS may advertise a service that can be provided by the device, and a service end of a seeker device as another device supporting WFDS may instruct the ASP to seek a device which will use the service. That is, conventional systems can support WFDS between devices through the ASP.

Referring to FIG. 10, the ASP can support multiple interfaces. For example, the ASP can support multiple interfaces for performing service discovery. In addition, the ASP can support multiple interfaces for performing service connection.

For example, multiple interfaces which perform service discovery may be at least one of Wi-Fi Direct, NAN (Neighbor Awareness Networking), NFC (Near Field Communication), BLE (Bluetooth Low Energy) and WLAN Infrastructure.

In addition, the multiple interfaces which perform service discovery may be at least one of Wi-Fi Direct, P2P and infrastructure. For example, the ASP can support multiple frequency bands. Here, the multiple frequency bands may be 2.4 GHz, 5 GHz and 60 GHz, for example. In addition, the ASP can support information about frequency bands below 1 GHz. That is, the ASP can support multiple frequency bands and the frequency bands are not limited to specific frequency bands.

Referring to FIG. 10, a first device may perform device discovery or service discovery for a first service using the ASP. Then, when device discovery or service discovery has been sought, the first device may perform service connection on the basis of the seeking result. Here, an interface used to seek service discovery and an interface used for service connection may differ from each other and may be selected from the multiple interfaces.

In this case, information or parameters for supporting the above-mentioned interfaces may be used in the service application platform (ASP).

With respect to the aforementioned ASP, for example, a service end of a device may acquire information about a service discovery method and a service connection method capable of supporting a first service from the ASP. Here, the first service may be a service provided by the device and is not limited to a specific service.

The service end of the device may call an AdvertiseService( ) or SeekService( ) method from the ASP on the basis of the information acquired from the ASP. That is, the device can use the ASP as an advertiser or a seeker to perform service discovery for the first service, which may be the same as the conventional ASP operation. In addition, the device may perform service connection on the basis of the service discovery result after service discovery for the first service is performed. Here, service connection may be P2P connection or WLAN infrastructure connection. For example, both the service connections support multiple frequency bands and can be performed on the basis of a desired band.

More specifically, referring to FIG. 10a, the service end of the device may call getPHY_status(service_name) method and send a message about a service to be used to the ASP. Here, the service end may receive a return value from the ASP to acquire information on multiple frequency bands with respect to service discovery methods and service connection methods supported by the ASP. Accordingly, the device may notify the ASP of a preferred connection method and a preferred frequency band for the service and acquire information about the service discovery methods and the service connection methods supported by the ASP. The ASP may perform service discovery on the basis of the information received from the service end to seek a specific device and connect the device such that the service can be used.

Here, getPHY_status(service_name) may include information as shown in Table 1, for example. Information shown in right parts of Table 1 is subordinate to information shown at the left of Table 1.

TABLE 1

| Connectivity | P2P | Multiband | 2.4, 5, 60 GHz | |
|---|---|---|---|---|
| methods | | information | | |
| | Infrastructure | BSSID | | |
| | information | Multiband | 2.4, 5, 60 GHz | Channel |
| | | information | | Index per |
| | | | | band |

| Service | NAN | | |
|---|---|---|---|
| Discovery | BTLE | | |
| methods | NFC | | |
| | Infrastructure | | |
| | P2P | Multiband | 2.4, 5, 60 GHz |
| | | information | |

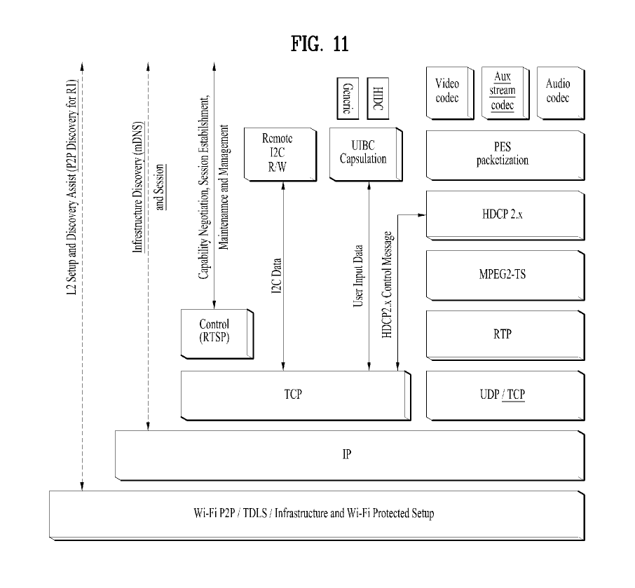

FIG. 11 is a structural view illustrating a data and control plane for use in a WFD device. Referring to FIG. 11, WFD devices may perform connection using any one of Wi-Fi Direct (Wi-Fi P2P), Tunneled Direct Link Setup (TDLS), or Infrastructure. For example, WFD devices for use in a conventional system may perform connection through any one of Wi-Fi Direct or TDLS. In contrast, WFD devices for use in the present system may perform connection through any one of Wi-Fi Direct, TDLS or Infrastructure. For example, the WFD device may perform search and connection of the service on the basis of the above-mentioned ASP, without being limited thereto.

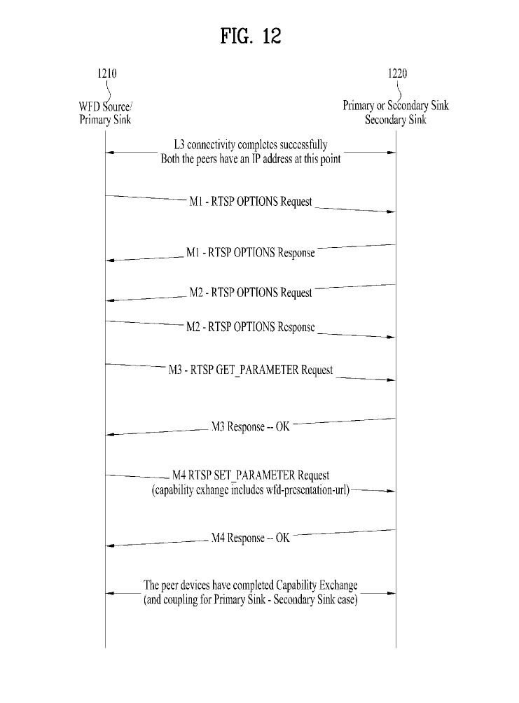

FIG. 12 is a conceptual diagram illustrating a method for allowing a WFD source device and a WFD sink device to exchange a Real Time Streaming Protocol (RTSP) message.

Referring to FIG. 12, a WFD source device 1210 and a WFD sink device 1220 may perform session establishment (or session connection) on the basis of the RTSP message. Thereafter, the WFD source device 1210 and the WFD sink device 1220 may provide streaming indicating realtime information through RTP (Real-time Transport Protocol).

In this case, when session establishment is performed, the WFD source device 1210 may transmit an RTSP M1 message to the WFD sink device 1220. In this case, the RTSP M1 message may be a message requesting initiation of an RTSP procedure. Thereafter, the WFD sink device 1220 may transmit an RTSP M2 message to the WFD source device 1210. RTSP M2 message may include not only information as to whether the RTSP procedure can be initiated, but also RTSP option information.

Thereafter, the WFD source device 1210 may exchange an RTSP M3 message and an RTSP M4 message with the WFD sink device 1220. In this case, the RTSP M3 message and the RTSP M4 message may be based on a capability negotiation procedure of the WFD source device 1210 and the WFD sink device 1220. That is, the WFD source device 1210 and the WFD sink device 1220 may exchange the RTSP M3 message and the RTSP M4 message with each other, and may thus exchange mutual capability information about session establishment with each other. After that, the WFD source device 1210 and the sink device 1220 may perform session establishment by exchanging the RTSP M5 message, the RTSP M6 message, and the RTSP M7 message with each other. In this case, for example, session establishment initiation about the WFD source device 1210 and the WFD sink device 1220 may be performed on the basis of the RTSP M5 message. Thereafter, the WFD source device 1210 and the WFD sink device 1220 may exchange information about session establishment through the RTSP M6 message and the RTSP M7 message with each other, and may perform session establishment for providing streaming.

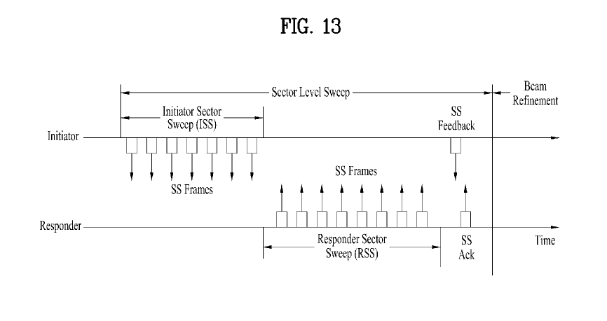

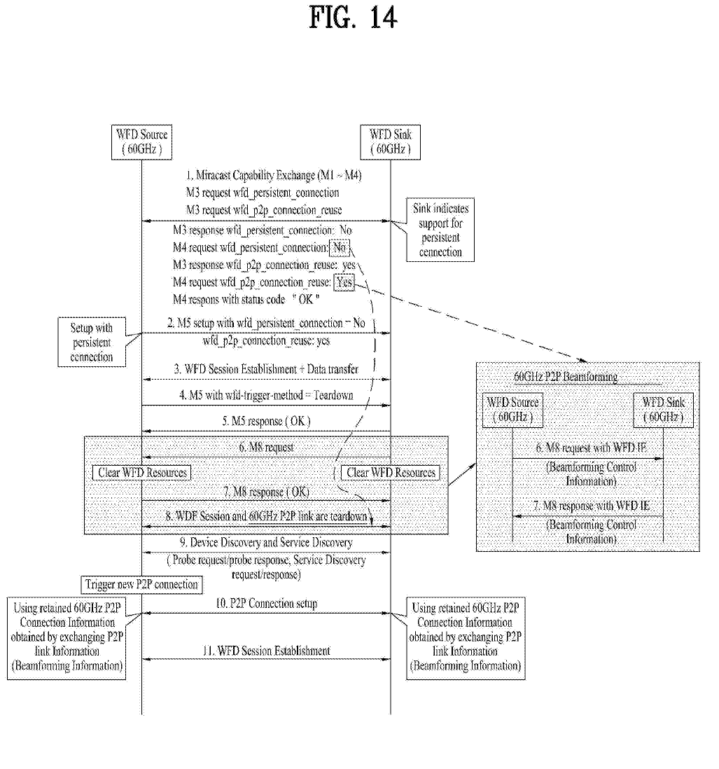

FIG. 13 is a conceptual diagram illustrating a beamforming training process applicable to the present invention. Basically, the beamforming procedure applicable to the present invention may be broadly classified into a Sector Level Sweep (SLS) phase and a BRP (Beam Refinement Protocol or Beam Refinement Phase) phase. In this case, the BRP process may be optionally carried out.

A device (or a station (STA) or a WFD device) scheduled to transmit data through beamforming will hereinafter be referred to as an initiator, and a device (or a station (STA) or WFD device) scheduled to receive data from the initiator may hereinafter be referred to as a responder.

In BF training encountered in Association BeamForming Training (A-BFT), an AP or PCP/AP may be an initiator, and a non-AP or non-PCP/AP STA may be a responder. In BF training generated in SP allocation, a source (EDMG) STA of the SP may be an initiator, and a destination STA of the SP may be a responder. In BF training within TXOP (Transmission Opportunity) allocation, a TXOP holder may be an initiator, and a TXOP responder may be a responder.

A link from the initiator to the responder may hereinafter be referred to as an initiator link, and a link from the responder to the initiator may hereinafter be referred to as a responder link.

In order to more reliably transmit data and control information in a 60 GHz band supported by an 11ay system applicable to the present invention, the directional transmission scheme instead of the omni-transmission method may be applied to the present invention.

As a process for the above operation, devices to be used for data transmission/reception may recognize a TX or RX best sector for the initiator or the responder through the SLS phase.

BF training may be started with the SLS (Sector Level Sweep) from the initiator. The SLS phase may enable two devices to communicate with each other in a control PHY rate or an upper MCS. Specifically, the SLS phase may provide transmission of only BF training.

In this case, the SLS is a protocol for performing link detection in an 802.11ay system applicable to the present invention. The SLS may be a beam training scheme for successively transmitting/receiving a frame having performance information of the Rx channel link while simultaneously allowing the network nodes to change only the beam direction, such that an index (e.g., SNR(Signal to Ratio), RSSI (Received Signal Strength Indicator), etc.) indicating the optimum frame from among the successfully received frames can select the best beam direction, as described above.

In addition, when a request from the initiator or the responder is present, the BRP (Beam Refinement Protocol or Beam Refinement Phase) may be arranged subsequent to the SLS.

An object of the RRP is to implement Rx training as well as to implement iterative refinement of Antenna Weight Vectors (AWVs) of all transmitters and receivers of all devices. If one of STAs participating in beam training selects to use a Tx antenna pattern, Rx training may be carried out as a portion of the SLS phase.

In more detail, the SLS phase may include the following four elements. The SLS phase may include an Initiator Sector Sweep (ISS) for training the initiator link, a Responder Sector Sweep (RSS) for training the responder link, an SSW feedback, and an SSW ACK.

In this case, the initiator may start the SLS phase by transmitting ISS frame(s). The responder may not start transmission of RSS frame(s) prior to successful completion of ISS. However, the above-mentioned operation may be exceptionally used when ISS occurs in BTI. The initiator may not start SSW feedback before the RSS phase is not successfully completed. However, the above-mentioned operation may be exceptionally used when the RSS occurs in A-BFT. The responder may not start an SSW ACK of the initiator within the A-BFT. The responder may immediately start SSW ACK of the initiator after SSW feedback is successfully completed.

The BF frame transmitted from the initiator during the SLS phase may include (EDMG) beacon frame, SSW frame, and SSW feedback frame. The BF frame to be transmitted by the responder during the SLS phase may include an SSW frame and an SSW-ACK frame.

When each of the initiator and the responder performs TXSS (Transmit Sector Sweep) during the SLS phase, the initiator and the responder may possess their own Tx sectors at a time corresponding to the end of the SLS phase. If ISS or RSS employs a receive sector sweep (Rx sector sweep), the responder and the initiator may possess their own Rx sectors. The device may not change Tx power during the sector sweep.

When the WFD service is reused in consideration of the 60 GHz support WFD device, a method for reusing legacy P2P connection will hereinafter be described. In more detail, when using the 60 GHz support WFD device, there is a need to select the sector in consideration of the beam direction, as described above. However, when WFD devices perform connection, overhead may increase whenever the SLS phase is performed, such that there is a need to efficiently exchange associated information. A method for allowing the 60 GHz support WFD device to perform connection by reusing P2P connection.

For example, the RTSP parameter may be established on the basis of the above-mentioned RTSP message so as to reuse 60 GHz P2P connection. In this case, “wfd_persistent_connect” may be established as the RTSP parameter. In this case, “wfd_persistent_connect” parameter may be a parameter for indicating whether 60 GHz P2P connection will be continuously retained after completion of Wi-Fi Display (WFD) service (i.e., WFD Session Teardown), and may indicate whether 60 GHz P2P connection will be retained on the basis of the following Table 2. For example, the above-mentioned parameter may be contained in RTSP M3/M4/M5 messages.

```
TABLE 2
0 (no):
    60 GHz P2P connection is not retained (i.e., contained in M4)
    Absence of corresponding Capability is indicated (i.e., contained in
    M3 Response)
1 (yes):
    60 GHz P2P connection is retained (i.e., contained in M4)
    Presence of corresponding Capability is indicated (i.e., contained in
    M3 Response)
```

More specifically, when the above-mentioned parameter is contained in M3, the WFD source device may query the WFD sink device for the presence or absence of capability capable of continuously retaining 60 GHz P2P connection after completion of the WFD service (i.e., WFD Session Teardown). That is, the WFD source device may confirm whether the WFD sink device can retain 60 GHz P2P connection on the basis of the above-mentioned parameter contained in the M3 message after completion of the WFD service. In this case, the WFD sink device may include specific information about the presence or absence of capability capable of retaining 60 GHz P2P connection in the M3 response message, and may then transmit the resultant M3 response message to the WFD source device. For example, the M3 response message may include a value of “wfd_persistent_connect” as a parameter. In this case, when the WFD sink device has capability capable of retaining 60 GHz P2P connection, the “wfd_persistent_connect” value may be set to a first value (or a positive value), and may then be transmitted to the WFD source device. For example, when the WFD sink device does not include the capability capable of retaining 60 GHz P2P connection, the “wfd_persistent_connect” value may be set to a second value (or a negative value), and may then be transmitted to the WFD source device. As a result, the WFD source device may confirm the presence or absence of specific information as to whether the WFD sink device can retain 60 GHz P2P connection.

In another example, when the above-mentioned parameter is contained in the M4 message, the WFD sink device may be notified of specific information as to whether 60 GHz P2P connection will be retained after completion of WFD session. That is, the WFD source device may decide whether 60 GHz P2P connection will be retained, and may inform the WFD sink device of the decided information. That is, information as to whether 60 GHz P2P connection is retained may be shared by the WFD sink device during the WFD session connection (establishment) process.

In another example, when the above-mentioned parameter is contained in the M5 request message (SETUP Message), information as to whether 60 GHz P2P connection will be retained after completion of WFD session may be shared by the WFD sink device during WFD session connection (establishment). That is, information as to whether 60 GHz P2P connection will be retained during the WFD session connection may be indicated on the basis of the above-mentioned parameter.

In another example, “wfd_p2p_connection_reuse” parameter acting as the parameter contained in the RTSP message may be established. In this case, “wfd_p2p_connection_reuse” may be a parameter for indicating whether previous 60 GHz P2P connection will be reused for a future WFD service after completion of the WFD service, and associated information is shown in the following Table 3. For example, the above-mentioned parameter may be contained in RTSP M3/M4/M5 messages.

```
TABLE 3
0 (no):
    Previous 60 GHz P2P connection is not used (i.e., contained in M4)
    Absence of corresponding Capability is indicated (i.e., contained in
    M3 Response)
1 (yes):
    Previous 60 GHz P2P connection is used (i.e., contained in M4)
    Presence of corresponding Capability is indicated (i.e., contained in
    M3 Response)
```

More specifically, when “wfd_p2p_connection_reuse” is contained in the M3 request message and the WFD source device may query the Future Wi-Fi Display (WFD) Service whether the WFD sink device has capability capable of reusing the previous 60 GHz P2P connection. That is, the WFD source device may recognize whether the WFD sink device has capability indicating whether the WFD sink device can reuse the 60 GHz P2P connection through the above-mentioned parameter. In this case, when the WFD sink device can reuse the 60 GHz P2P connection, the “wfd_connection_reuse” value for the M3 response is set to the first value (or a positive value), and the resultant information may be transmitted to the WFD source device. For example, when the WFD sink device is unable to reuse the 60 GHz P2P connection, the “wfd_persistent_connect” value is set to the second value (or negative value), and the resultant information may be transmitted to the WFD source device. As a result, the WFD source device may confirm whether the WFD sink device can reuse the 60 GHz P2P connection.

For example, when the “wfd_connection_reuse” parameter is contained in the M4 request message, the WFD source device may decide whether previous 60 GHz P2P connection will be reused during the Future Wi-Fi Display Service, and may inform the WFD sink device of the decided result.

For example, when the “wfd_connection_reuse” parameter is contained in the M5 request message (Setup Message), it may be possible to provide the WFD sink device with specific information as to whether previous 60 GHz P2P connection will be used during the Future Wi-Fi Display Service during WFD session establishment. That is, during the WFD session connection process based on the above parameter, information as to whether 60 GHz P2P connection will be reused may be shared.

That is, as the RTSP parameter, information as to whether 60 GHz P2P connection will be retained or information as to whether previous 60 GHz P2P connection will be reused may be indicated through “wfd_persistent_connect” or “wfd_connection_reuse”.

For example, FIG. 14 is a conceptual diagram illustrating a method for reusing previous 60 GHz P2P connection using the P2P interface.

In this case, the 60 GHz support WFD source device may determine whether 60 GHz P2P connection will be retained after completion of WFD session through “wfd_persistent_connect” and “wfd_connection_reuse” RTSP parameters during the capability negotiation phase (e.g., M1˜M4). In this case, for the WFD session for the Future WFD service, information as to whether 60 GHz P2P connection will be reused while simultaneously being retained may be negotiated and decided.

For example, it may be possible to consider an exemplary case in which the “wfd_persistent_connect” parameter value is denoted by “No” and the “wfd_connection_reuse” parameter value is denoted by “Yes”.

In this case, during the capability negotiation (M1˜M4) and WFD session setup phase, the “wfd_persistent_connect” and “wfd_connection_reuse” values may be established. In this case, as described above, since the “wfd_persistent_connect” parameter value is set to “No”, the WFD source device and the WFD sink device may cancel 60 GHz P2P connection when the WFD session is completed. That is, after the WFD source device and the WFD sink device exchange the M8 message with each other, the WFD source device and the WFD sink device may cancel the 60 GHz P2P connection and at the same time may complete the WFD session.

However, when the “wfd_connection_reuse” value is set to a positive value during the capability negotiation (M1˜M4) and the WFD session setup (e.g., M5 Request with SETUP) phase, previous 60 GHz P2P connection may be reused when the future WFD session is started. That is, although 60 GHz P2P connection is not retained, information associated with 60 GHz P2P connection must be exchanged and retained in the end of WFD session (RTSP M8 exchange phase) such that 60 GHz P2P connection can be reused during initiation of the future WFD session. In this case, for example, 60 GHz connection information may be shown in the following Table 4. That is, information associated with 60 GHz P2P connection may be included in the 60 GHz connection information.

TABLE 4

MAC Address
60 GHz Beamforming Control information
Credential information
Operating Channel
Listen Channel
Channel list
P2P Group BSSID
P2P Group ID
etc

In this case, for example, as shown in Table 4, 60 GHz connection information may include 60 GHz Beamforming Control Information, and associated information may be shown in the following Table 5. In association with 60 GHz beamforming control information, there is a need to decide the best sector from among several sectors in consideration of the beam directivity at 60 GHz. For example, BS ID (Best Sector ID) may be contained as 60 GHz beamforming control information as shown in Table 5. In this case, BS ID may indicate the best sector ID of the reception (Rx) device from the reception viewpoint of the transmission (Tx) device. The WFD source device and the WFD sink device may perform overhearing of the SLS phase associated with the AP, and the best sector ID information of the WFD sink device may be confirmed. IN this case, the best sector ID may be indicated through the BS ID field, and the WFD sink device may transmit the packet through the best sector ID, and may perform packet transmission in consideration of 60 GHz.

For example, after the WFD sink device performs overhearing of the SLS phase associated with the AP along with the WFD source device, the WFD sink device may confirm the best sector ID information of the WFD source device. In this case, the best sector ID may be indicated through the BS ID field, and the WFD source device may transmit the packets through the best sector ID, and may perform packet transmission in consideration of 60 GHz. However, the scope or spirit of the present invention is not limited thereto.

TABLE 5

| | | |
|---|---|---|
| Transmission | Reception Address | BS (Best Sector) ID |
| Address | e.g: MAC Address | Best Sector ID of Rx device from reception |
| e.g: MAC Address | of Rx device | viewpoint of Tx device. |
| of Tx device | | e.g: After TA performs overhearing of the |
| | | Sector Level Sweep (SLS) of RA, the Best |
| | | Sector ID capable of being received from |
| | | RA device is extracted and indicated. |
| | | In this case, RA Device forms the beam using |
| | | the Sector ID corresponding to BS ID when |
| | | packet is transmitted to TA Device, such |
| | | that packet can be transmitted. |

In another example, information as to whether the WFD device supports 60 GHz may be included as 60 GHz P2P connection information. In this case, 60 GHz P2P connection can be performed as described above only when the WFD device supports 60 GHz, and information indicating the above fact may be needed. That is, 60 GHz based P2P connection may be performed only when the WFD device supports 60 GHz as described above.

For example, 60 GHz P2P connection associated information may be contained in at least one of P2P IE (Information Element) and WFD IE, without being limited thereto.

In this case, as shown in FIG. 14, after the WFD session is completed and the 60 GHz P2P connection is cancelled, when 60 GHz P2P connection is triggered for the WFD source device and the WFD sink device so as to use a new WFD service, the WFD source device performs device search for the WFD sink device and exchanges of messages for searching for a service using the 60 GHz P2P connection information that has been acquired through exchange of the previous M8 message. Messages for device search and service search may be exchanged between one device and the counterpart device (e.g., step ‘9’ of FIG. 14). That is, during the M8 message exchange process used as a previous WFD session process, the WFD source device and the WFD sink device may pre-share necessary information in consideration of 60 GHz P2P connection. Thereafter, after 60 GHz P2P connection is completed, the process for WFD session connection may be carried out.

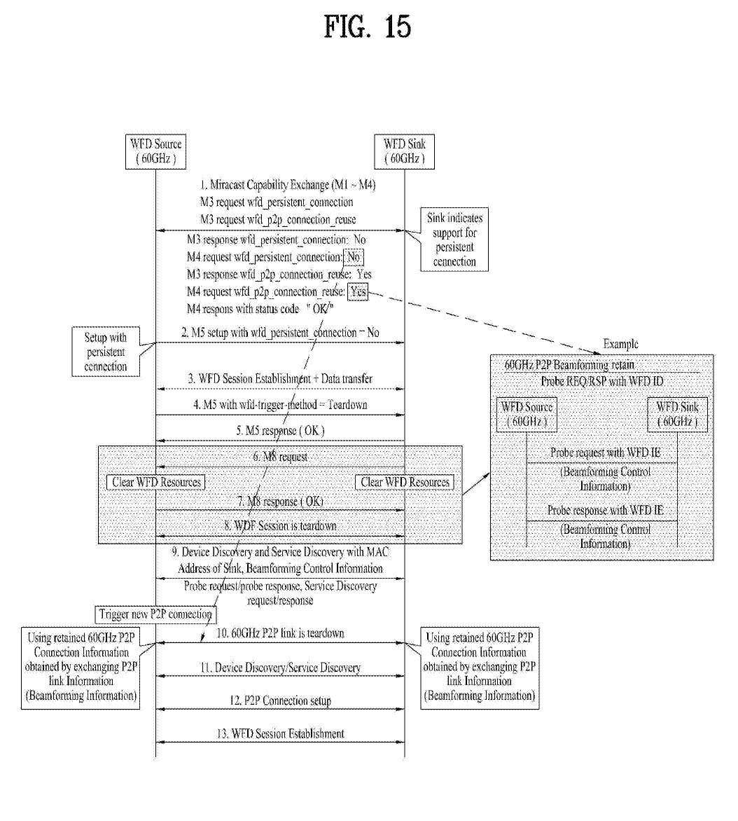

In another example, FIG. 15 is a concetual diagram illustrating a method for reusing legacy 60 GHz P2P connection using the P2P interface.

In this case, the 60 GHz support WFD source device may decide whether 60 GHz P2P connection will be retained after completion of the WFD session through “wfd_persistent_connect” and “wfd_connection_reuse” RTSP parameters in the capability negotiation phase (e.g., M1˜M4). In this case, for the WFD session for the future WFD service, it may be possible to negotiate and determine information as to whether 60 GHz P2P connection will be reused on the condition that previous 60 GHz P2P connection is retained.

For example, an exemplary case in which the “wfd_persistent_connect” parameter value is set to “No” and the “wfd_connection_reuse” parameter value is set to “Yes” may be considered.

In this case, in the capability negotiation (M1˜M4) and WFD session setup phase, “wfd_persistent_connect” and “wfd_connection_reuse” values may be established. In this case, as described above, since the “wfd_persistent_connect” parameter value is set to “No”, the WFD source device and the WFD sink device may cancel 60 GHz P2P connection in the end of the WFD session. That is, after the WFD source device and the WFD sink device perform exchange of the M8 message, the WFD session is ended and at the same time the 60 GHz P2P connection can be cancelled.

However, during the capability negotiation (M1˜M4) and WFD session establishment (e.g., M5 Request with SETUP) phase, when the “wfd_connection_reuse” value is set to a positive value, previous 60 GHz P2P connection may be reused when the future WFD session is started. That is, although 60 GHz P2P connection is not retained, 60 GHz P2P connection may be reused when the future WFD session is started. In this case, for example, differently from FIG. 14, the WFD source device and the WFD sink device may perform an addition process after transmission of the RTSP message for WFD session completion in a manner that the 60 GHz P2P connection can be reused before the future WFD session is started. For example, as shown in the step ‘9’ of FIG. 15, the WFD source device and the WFD sink device may exchange and retain 60 GHz P2P information using the device search/service search message. In this case, since the “wfd_persistent_connect” parameter value is set to “No”, 60 GHz P2P connection may be cancelled after completion of 60 GHz P2P information exchange. In this case, 60 GHz P2P connection information is shown in the following Table 6. That is, information associated with 60 GHz connection may be included in the 60 GHz P2P connection information.

TABLE 6

MAC Address
60 GHz Beamforming Control information
Credential information
Operating Channel
Listen Channel
Channel list
P2P Group BSSID
P2P Group ID
etc

In this case, for example, as shown in the following Table 6, 60 GHz Beamforming Control Information may be contained in 60 GHz connection information, and associated information may be identical to those of the following Table 7. In association with 60 GHz beamforming control information, there is a need to decide the best sector from among several sectors in consideration of the beam directivity at 60 GHz. For example, as shown in the following Table 7, BS ID (Best Sector ID) may be contained as 60 GHz beamforming control information. In this case, the Tx device may indicate the best sector ID of the Rx device from the reception viewpoint of the Tx device. For example, the WFD source device performs overhearing of the SLS phase associated with the AP along with the WFD sink device, and may confirm the best sector ID information of the WFD sink device. In this case, the best sector may be indicated through the BS ID field and the WFD sink device perform packet transmission through the best sector ID, such that packet transmission may be performed in consideration of 60 GHz.

For example, after the WFD sink device performs overhearing of the SLS phase associated with the AP along with the WFD source device, the WFD sink device may confirm the best sector ID information of the WFD source device. In this case, the best sector ID may be indicated through the BS ID field, and the WFD source device performs packet transmission through the best sector ID, such that packet transmission can be performed in consideration of 60 GHz. However, the scope or spirit of the present invention is not limited thereto.

TABLE 7

| | | |
|---|---|---|
| Transmission | Reception Address | BS (Best Sector) ID |
| Address | e.g: MAC Address | Best Sector ID of Rx device from reception |
| e.g: MAC Address | of Rx device | viewpoint of Tx device. |
| of Tx device | | e.g: After TA performs overhearing of the |
| | | Sector Level Sweep (SLS) of RA, the Best |
| | | Sector ID capable of being received from |
| | | RA device is extracted and indicated. In this |
| | | case, RA Device forms the beam using the |
| | | Sector ID corresponding to BS ID when |
| | | packet is transmitted to TA Device, such |
| | | that packet can be transmitted |

In another example, information as to whether the WFD device supports 60 GHz may be contained as 60 GHz P2P connection associated information. In this case, as described above, 60 GHz P2P connection may be performed only when the WFD device supports 60 GHz, such that information indicating the above fact is needed. That is, 60 GHz P2P connection may be performed only when the WFD device supports 60 GHz, as described above.

For example, 60 GHz P2P connection associated information may be contained in at least one of P2P IE (Information Element) and WFD IE, and may then be transmitted. However, the scope or spirit of the present invention is not limited thereto.

In addition, as shown in FIG. 15, after the WFD session is completed and 60 GHz P2P connection is cancelled, when 60 GHz P2P connection between the WFD source device and the WFD sink device is triggered to use a new WFD service, the WFD source device may exchange the device search/service search message with the WFD sink device using 60 GHz P2P connection information acquired through the previous device search/service search message exchange. Device search/service search message may be exchanged between one device and the counterpart device (e.g., step ‘11’ of FIG. 15). That is, the WFD source device and the WFD sink device may share 60 GHz P2P connection information with each other before connecting to the next WFD session connection. Thereafter, when 60 GHz P2P connection is completed, a process for WFD session connection may be carried out.

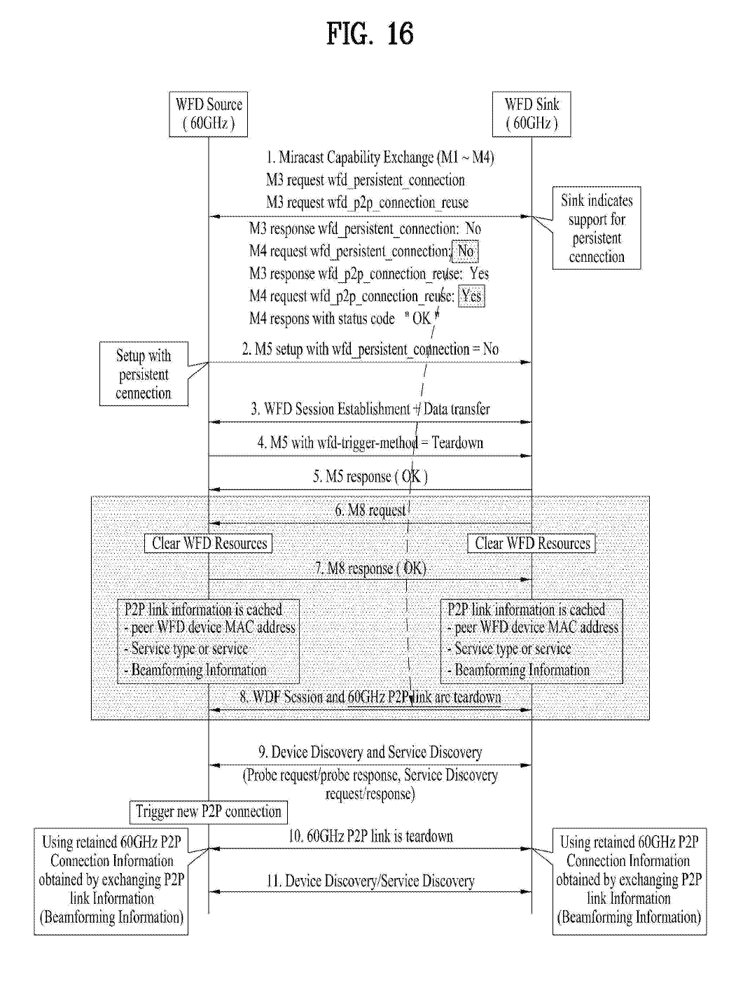

In another example, FIG. 16 is a conceptual diagram illustrating a method for reusing legacy 60 GHz P2P connection using the P2P interface.

In this case, the 60 GHz support WFD source device may determine whether 60 GHz P2P connection will be retained after completion of WFD session through “wfd_persistent_connect” and “wfd_connection_reuse” RTSP parameters during the capability negotiation phase (e.g., M1˜M4). In this case, for the WFD session for the Future WFD service, information as to whether 60 GHz P2P connection will be reused while simultaneously being retained may be negotiated and decided.

For example, it may be possible to consider an exemplary case in which the “wfd_persistent_connect” parameter value is denoted by “No” and the “wfd_connection_reuse” parameter value is denoted by “Yes”.

In this case, during the capability negotiation (M1˜M4) and WFD session setup phase, the “wfd_persistent_connect” and “wfd_connection_reuse” values may be established. In this case, as described above, since the “wfd_persistent_connect” parameter value is set to “No”, the WFD source device and the WFD sink device may cancel 60 GHz P2P connection when the WFD session is completed. That is, after the WFD source device and the WFD sink device exchange the M8 message with each other, the WFD source device and the WFD sink device may cancel the 60 GHz P2P connection and at the same time may complete the WFD session.

However, when the “wfd_connection_reuse” value is set to a positive value during the capability negotiation (M1˜M4) and the WFD session setup (e.g., M5 Request with SETUP) phase, previous 60 GHz P2P connection may be reused when the future WFD session is started. That is, although 60 GHz P2P connection is not retained, information associated with 60 GHz P2P connection must be exchanged and retained in the end of WFD session (RTSP M8 exchange phase) such that 60 GHz P2P connection can be reused during initiation of the future WFD session.

For example, differently from FIG. 14, after the RTSP M8 message for WFD session completion is transmitted for reuse of the 60 GHz P2P connection, the WFD source device and the WFD sink device may perform caching of 60 GHz P2P information. That is, after completion of the WFD session, the WFD source device and the WFD sink device may store information about 60 GHz P2P connection prior to cancellation of 60 GHz P2P connection. For example, caching (or storage) information may include at least one of MAC address, service type, service, and beamforming information of the neighbor WFD device. In another example, 60 GHz P2P connection information is shown in the following Table 8. That is, information associated with 60 GHz P2P connection may be contained in the 60 GHz P2P connection information.

TABLE 8

MAC Address
60 GHz Beamforming Control information
Credential information
Operating Channel
Listen Channel
Channel list
P2P Group BSSID
P2P Group ID
etc

In this case, for example, as shown in the following Table 8, 60 GHz Beamforming Control Information may be contained in 60 GHz connection information, and associated information may be identical to those of the following Table 9. In association with 60 GHz beamforming control information, there is a need to decide the best sector from among several sectors in consideration of the beam directivity at 60 GHz. For example, as shown in the following Table 9, BS ID (Best Sector ID) may be contained as 60 GHz beamforming control information. In this case, the Tx device may indicate the best sector ID of the Rx device from the reception viewpoint of the Tx device. For example, the WFD source device performs overhearing of the SLS phase associated with the AP along with the WFD sink device, and may confirm the best sector ID information of the WFD sink device. In this case, the best sector may be indicated through the BS ID field and the WFD sink device perform packet transmission through the best sector ID, such that packet transmission may be performed in consideration of 60 GHz.

For example, after the WFD sink device performs overhearing of the SLS phase associated with the AP along with the WFD source device, the WFD sink device may confirm the best sector ID information of the WFD source device. In this case, the best sector ID may be indicated through the BS ID field, and the WFD source device performs packet transmission through the best sector ID, such that packet transmission can be performed in consideration of 60 GHz. However, the scope or spirit of the present invention is not limited thereto.

TABLE 9

| | | |
|---|---|---|
| Transmission | Reception Address | BS (Best Sector) ID |
| Address | e.g: MAC Address | Best Sector ID of Rx device from reception |
| e.g: MAC Address | of Rx device | viewpoint of Tx device. |
| of Tx device | | e.g: After TA performs overhearing of the |
| | | Sector Level Sweep (SLS) of RA, the Best |
| | | Sector ID capable of being received from |
| | | RA device is extracted and indicated. In this |
| | | case, RA Device forms the beam using the |
| | | Sector ID corresponding to BS ID when |
| | | packet is transmitted to TA Device, such |
| | | that packet can be transmitted |

In another example, information as to whether the WFD device supports 60 GHz may be contained as 60 GHz P2P connection associated information. In this case, as described above, 60 GHz P2P connection may be performed only when the WFD device supports 60 GHz, such that information indicating the above fact is needed. That is, 60 GHz P2P connection may be performed only when the WFD device supports 60 GHz, as described above.

For example, 60 GHz P2P connection associated information may be contained in at least one of P2P IE (Information Element) and WFD IE, and may then be transmitted. However, the scope or spirit of the present invention is not limited thereto.

In addition, as shown in FIG. 16, after the WFD session is completed and 60 GHz P2P connection is cancelled, when 60 GHz P2P connection between the WFD source device and the WFD sink device is triggered to use a new WFD service, the WFD source device may exchange the device search/service search message for the WFD sink device with the WFD sink device using previously-cached 60 GHz P2P connection information. Device search/service search message may be exchanged between one device and the counterpart device (e.g., step ‘9’ of FIG. 16). That is, the WFD source device and the WFD sink device may pre-share necessary information with each other in consideration of 60 GHz P2P connection, and may then perform caching of the resultant information. Thereafter, when 60 GHz P2P connection is completed, a process for WFD session connection may be carried out.

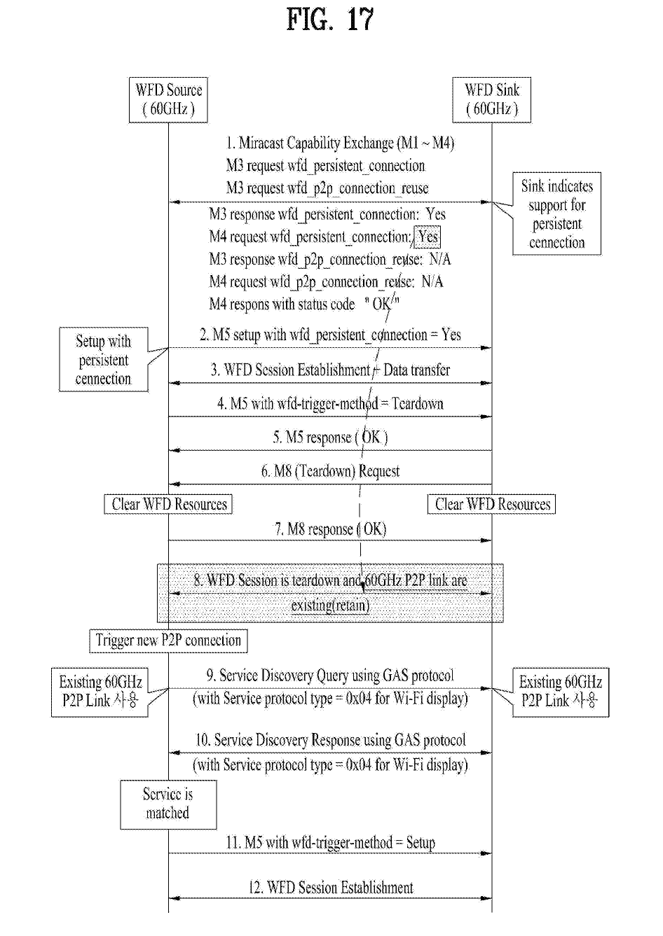

In another example, FIG. 17 is a conceptual diagram illustrating a method for reusing legacy 60 GHz P2P connection using the P2P interface.

During the capability negotiation phase (e.g., M1˜M4), the 60 GHz support WFD source device may determine whether 60 GHz P2P connection will be retained after completion of WFD session through “wfd_persistent_connect” and “wfd_connection_reuse” RTSP parameters, and may negotiate and determine information as to whether 60 GHz P2P connection will be reused.

In this case, FIG. 17 illustrates the “wfd_persistent_connect” parameter value which is set to “Yes”. For example, during the capability negotiation (M1˜M4) and WFD session setup phase, the “wfd_persistent_connect” and “wfd_connection_reuse” values may be established. In this case, since the “wfd_persistent_connect” parameter value is set to “Yes”, the WFD source device and the WFD sink device may not cancel 60 GHz P2P connection although the WFD session is completed.

In this case, after completion of the WFD session, when the new WFD service use is triggered between the WFD source device and the WFD sink device, the WFD source device may exchange the device search/service search messages with the counterpart device. That is, since 60 GHz P2P connection is retained, the 60 GHz P2P connection process is no longer required, the WFD source device can perform the WFD session connection process during matching of a service (Service type=Wi-Fi Display) between the WFD source device and the WFD sink device.

In this case, for example, when 60 GHz P2P connection is retained on the basis of “wfd_persistent_connect”, information as to whether 60 GHz P2P connection is reused is no longer required, such that the “wfd_connection_reuse” parameter may be set to a null value. However, the scope or spirit of the present invention is not limited thereto.

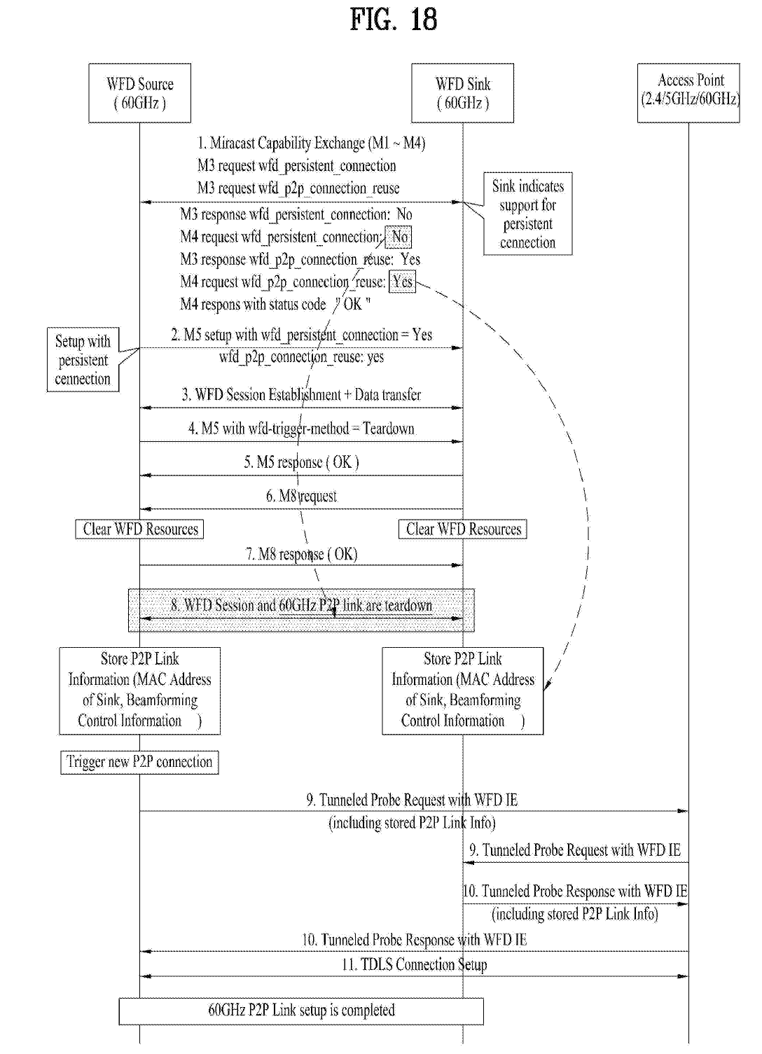

In another example, FIG. 18 is a conceptual diagram illustrating a method for reusing legacy 60 GHz P2P connection using the P2P interface.

Referring to FIG. 18, legacy 60 GHz P2P connection may be reused using the Wi-Fi Infrastructure. For example, during the capability negotiation phase (e.g., M1˜M4), the 60 GHz support source device may decide whether to retain 60 GHz P2P connection after completion of the WFD session through “wfd_persistent_connect” and “wfd_connection_reuse” RTSP parameters. In this case, for the WFD session for the Future WFD service, information as to whether 60 GHz P2P connection will be reused while simultaneously being retained may be negotiated and decided.

For example, it may be possible to consider an exemplary case in which the “wfd_persistent_connect” parameter value is denoted by “No” and the “wfd_connection_reuse” parameter value is denoted by “Yes”.

In this case, during the capability negotiation (M1˜M4) and WFD session setup phase, the “wfd_persistent_connect” and “wfd_connection_reuse” values may be established. In this case, as described above, since the “wfd_persistent_connect” parameter value is set to “No”, the WFD source device and the WFD sink device may cancel 60 GHz P2P connection when the WFD session is completed. That is, after the WFD source device and the WFD sink device exchange the M8 message with each other, the WFD source device and the WFD sink device may cancel the 60 GHz P2P connection and at the same time may complete the WFD session.

However, when the “wfd_connection_reuse” value is set to a positive value during the capability negotiation (M1˜M4) and the WFD session setup (e.g., M5 Request with SETUP) phase, previous 60 GHz P2P connection may be reused when the future WFD session is started. That is, although 60 GHz P2P connection is not retained, information associated with 60 GHz P2P connection must be exchanged and retained in the end of WFD session (RTSP M8 exchange phase) such that 60 GHz P2P connection can be reused during initiation of the future WFD session.

In this case, for example, 60 GHz connection information may be shown in the following Table 10. That is, information associated with 60 GHz P2P connection may be included in the 60 GHz connection information.

TABLE 10

MAC Address
60 GHz Beamforming Control information
Credential information
Operating Channel
Listen Channel
Channel list
P2P Group BSSID
P2P Group ID
etc

In this case, for example, as shown in Table 10, 60 GHz connection information may include 60 GHz Beamforming Control Information, and associated information may be shown in the following Table 11. In association with 60 GHz beamforming control information, there is a need to decide the best sector from among several sectors in consideration of the beam directivity at 60 GHz. For example, BS ID (Best Sector ID) may be contained as 60 GHz beamforming control information as shown in Table 5. In this case, BS ID may indicate the best sector ID of the reception (Rx) device from the reception viewpoint of the transmission (Tx) device. The WFD source device and the WFD sink device may perform overhearing of the SLS phase associated with the AP, and the best sector ID information of the WFD sink device may be confirmed. IN this case, the best sector ID may be indicated through the BS ID field, and the WFD sink device may transmit the packet through the best sector ID, and may perform packet transmission in consideration of 60 GHz.

For example, after the WFD sink device performs overhearing of the SLS phase associated with the AP along with the WFD source device, the WFD sink device may confirm the best sector ID information of the WFD source device. In this case, the best sector ID may be indicated through the BS ID field, and the WFD source device may transmit the packets through the best sector ID, and may perform packet transmission in consideration of 60 GHz. However, the scope or spirit of the present invention is not limited thereto.

TABLE 11

| | | |
|---|---|---|
| Transmission | Reception Address | BS (Best Sector) ID |
| Address | e.g: MAC Address | Best Sector ID of Rx device from reception |
| e.g: MAC Address | of Rx device | viewpoint of Tx device. |
| of Tx device | | e.g: After TA performs overhearing of the |
| | | Sector Level Sweep (SLS) of RA, the Best |
| | | Sector ID capable of being received from |
| | | RA device is extracted and indicated. In this |
| | | case, RA Device forms the beam using the |
| | | Sector ID corresponding to BS ID when |
| | | packet is transmitted to TA Device, such |
| | | that packet can be transmitted. |

In another example, information as to whether the WFD device supports 60 GHz may be included as 60 GHz P2P connection information. In this case, 60 GHz P2P connection can be performed as described above only when the WFD device supports 60 GHz, and information indicating the above fact may be needed. That is, 60 GHz based P2P connection may be performed only when the WFD device supports 60 GHz as described above.

For example, 60 GHz P2P connection associated information may be contained in at least one of P2P IE (Information Element) and WFD IE, without being limited thereto.

In addition, as shown in FIG. 18, after the WFD session is completed and 60 GHz P2P connection is cancelled, when use of a new WFD service is triggered, the WFD device search/WFD service search/P2P Link setup messages may be exchanged through the AP (Access Point) associated with the WFD source device and the WFD sink device.

More specifically, as shown in FIG. 18, the 60 GHz WFD source device and the 60 GHz WFD sink device may exchange messages with each other through the Wi-Fi infrastructure interface during the steps 9˜11. In this case, the steps 9˜10 may belong to the device search process. In this case, the step 11 may allow the WFD source device and the WFD sink device to perform link setup. In this case, for example, TDLS Setup Request, TDLS Setup Response, and TDLS Confirm messages may be used in the step 11. However, the TDLS frame used in the steps 9˜11 may be only exemplary, and may operate on the basis of different shapes of frames. That is, 60 GHz connection may be achieved through the Wi-Fi infrastructure interface. However, the scope or spirit of the present invention is not limited thereto. In addition, for example, when 60 GHz P2P connection is completed after completion of the step 11, the process for establishing the WFD session between the 60 GHz WFD source device and the 60 GHz sink device may be carried out, as described above.

FIG. 19 is a flowchart illustrating a method for reusing the 60 GHz P2P connection. The device may perform first WFD session connection on the basis of the RTSP message (S1910). In this case, as shown in FIGS. 1 to 18, the devices may exchange capability information on the basis of the M1˜M4 messages. In addition, the devices may exchange setup information on the basis of the M5˜M7 messages serving as the RTSP messages, such that WFD session connection may be carried out. For example, the device may be the WFD source device or the WFD sink device, without being limited thereto.

In this case, the RTSP message may include a first parameter and a second parameter. The first parameter may be the aforementioned “wfd_persistent_connect”, and the second parameter may be the aforementioned “wfd_connection_reuse”. That is, the first parameter may indicate whether 60 GHz P2P connection will be ended after completion of WFD session, and the second parameter may indicate whether previous 60 GHz P2P connection will be reused. For example, the first parameter may be contained in at least one of the M3 request message, the M4 request message, and the M5 request message, as described above. For example, the second parameter may be contained in at least one of the M3 request message, the M4 request message, and the M5 request message, as described above.

Subsequently, the devices may finish the connected first WFD session connection (S1920). In this case, as shown in FIGS. 1 to 18, the devices may exchange 60 GHz P2P associated information with each other on the basis of the first parameter and the second parameter. More specifically, when the first parameter indicates that 60 GHz P2P connection is not retained and the second parameter indicates that 60 GHz P2P connection is reused, the devices may exchange 60 GHz P2P with each other. For example, when the first parameter indicates that 60 GHz P2P connection is retained, the second parameter is meaningless, such that the second parameter may be set to a null value, as described above.

For example, information associated with 60 GHz P2P connection may include 60 GHz beamforming control information]. As described above, the 60 GHz support devices may perform the SLS phase on the basis of the beam directivity, resulting in exchange of that best sector information. In order to reduce overhead, the devices may include beamforming control information including the aforementioned best sector information in the 60 GHz P2P connection associated information, and may exchange the resultant information with each other. For example, the first WFD session connection may be ended on the basis of the M8 request message and the M8 response message. In this case, the 60 GHz P2P connection associated information may be contained in the M8 request message and the M8 response message, and may then be exchanged.

For example, 60 GHz P2P connection associated information may be cached to the device prior to completion of the first WFD session connection, as described above.

For example, before 60 GHz P2P connection is completed after completion of the first WFD session connection, the step for exchanging 60 GHz P2P connection associated information may further be carried out, such that 60 GHz P2P connection associated information may be exchanged.

Subsequently, the second WFD session connection may be carried out (S1930). In this case, as shown in FIGS. 1 to 18, the second WFD session may be a new WFD session connection after completion of the first WFD session. In this case, as described above, when the first parameter indicates that 60 GHz P2P connection is not retained and the second parameter indicates that 60 GHz P2P connection is reused, the devices may exchange 60 GHz P2P connection associated information with each other. In this case, when the devices performs the second WFD session connection, the devices may reuse the 60 GHz P2P connection that has been used in the first WFD session as previous 60 GHz P2P connection on the basis of the above-mentioned 60 GHz P2P connection associated information, and may then perform session connection. However, the scope or spirit of the present invention is not limited thereto.

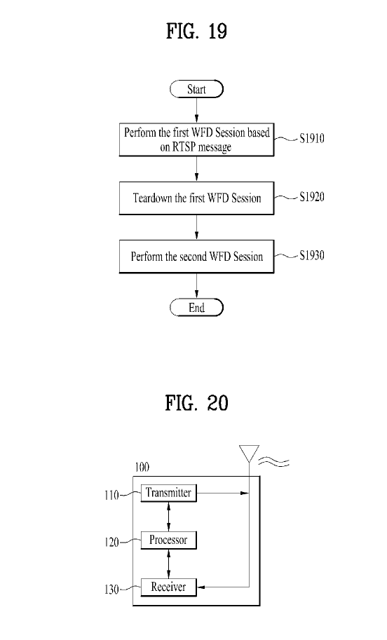

FIG. 20 is a block diagram illustrating a device according to an embodiment of the present invention.

The device may be a WFD support device. For example, the device may be a WFD source device or a WFD sink device.

Here, the device 100 may include a transmission module 110 which transmits radio signals, a reception module 130 which receives radio signals, and a processor 120 which controls the transmission module 110 and the reception module 130. The device 100 may perform communication with an external device using the transmission module 110 and the reception module 130. Here, the external device may be another device. For example, the external device may be another device connected through P2P, or an AP or a non-AP connected through WLAN infrastructure. Alternatively, the external device may be a base station. That is, the external device may be a device which can perform communication with the device 100 and is not limited to the above-described embodiments. The device 100 may transmit and receive digital data such as content using the transmission module 110 and the reception module 130.

According to an embodiment of the present invention, the processor 120 of the device 100 may establish an ASP session with a second device through a first connection method. Here, the processor 120 may transmit a session handover request to the second device using the transmission module 110. Then, the processor 120 may receive a session handover response from the second device using the reception module 130. Subsequently, the processor 120 may transmit Session Handover Confirm to the second device using the transmission module 110. Here, when the session handover response is received from the second device, the established ASP session may be handed over through a second connection method as described above.

The embodiments of the present invention may be achieved by various means, for example, hardware, firmware, software, or a combination thereof.

In a hardware configuration, the methods according to the embodiments of the present invention may be achieved by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, etc.

In a firmware or software configuration, the embodiments of the present invention may be implemented in the form of a module, a procedure, a function, etc. Software code may be stored in a memory unit and executed by a processor. The memory unit may be located at the interior or exterior of the processor and may transmit data to and receive data from the processor via various known means.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

Both a product invention and a process invention are described in the specification and the description of both inventions may be supplementary applied as needed.

As is apparent from the above description, the embodiments of the present invention can provide a method for providing a method for reusing P2P connection in a wireless communication system.

The embodiments of the present invention can provide a method for reusing P2P connection based on 60 GHz in a wireless communication system.

The embodiments of the present invention can provide a method for exchanging information needed for P2P connection in consideration of 60 GHz frequency characteristics.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for reusing 60 GHz P2P (Peer to Peer) connection by a terminal in a wireless communication system, comprising:
performing first Wi-Fi Display (WFD) session connection based on a Real Time Streaming Protocol (RTSP) message;
completing the first WFD session connection; and
performing second WFD session connection,
wherein the RTSP message includes a first parameter for indicating whether the 60 GHz P2P connection will be retained after completion of the first WFD session connection, and a second parameter for indicating whether the 60 GHz P2P connection will be reused after completion of the first WFD session connection, and
if the first parameter indicates that the 60 GHz P2P connection is not retained and the second parameter indicates that the 60 GHz P2P connection is reused, information associated with the 60 GHz P2P connection is exchanged when the first WFD session connection is completed.

2. The method according to claim 1, wherein:
the information associated with the 60 GHz P2P connection includes 60 GHz beamforming control information,
wherein the 60 GHz beamforming control information includes best sector ID (identifier) information.

3. The method according to claim 2, wherein:
the best sector ID information indicates a sector having the highest SNR (Signal Noise Ratio) or the highest RSSI (Received Signal Strength Indicator) from among a plurality of sectors established at 60 GHz.

4. The method according to claim 1, wherein:
the first WFD session connection is completed based on an M8 request message and an M8 response message, and
the 60 GHz P2P connection associated information is contained in the M8 request message and the M8 response message, and is then exchanged.

5. The method according to claim 1, wherein the 60 GHz P2P connection associated information is cached to the terminal, before the first WFD session connection is completed.

6. The method according to claim 1, further comprising:
after completion of the first WFD session connection, exchanging the 60 GHz P2P connection associated information prior to completion of the 60 GHz P2P connection.

7. The method according to claim 1, wherein:
when the first parameter indicates that the 60 GHz P2P connection is retained, the second parameter is set to a null value.

8. The method according to claim 1, wherein the first parameter is included in at least one of an M3 request message, an M4 request message, and an M5 request message.

9. The method according to claim 1, wherein the second parameter is included in at least one of an M3 request message, an M4 request message, and an M5 request message.

10. The method according to claim 1, wherein:
the first parameter is a ‘wfd_persistent_connect’ parameter, and
the second parameter is a “wfd_persistent_reuse’ parameter.

11. A terminal for reusing 60 GHz P2P (Peer to Peer) connection in a wireless communication system, comprising:
a receiver configured to receive information from an external terminal;
a transmitter configured to transmit information to the external terminal; and
a processor configured to control the receiver and the transmitter,
wherein the processor performs first Wi-Fi Display (WFD) session connection based on a Real Time Streaming Protocol (RTSP) message, completes the first WFD session connection, and performs second WFD session connection,
wherein the RTSP message includes a first parameter for indicating whether the 60 GHz P2P connection will be retained after completion of the first WFD session connection, and a second parameter for indicating whether the 60 GHz P2P connection will be reused after completion of the first WFD session connection, and
if the first parameter indicates that the 60 GHz P2P connection is not retained and the second parameter indicates that the 60 GHz P2P connection is reused, information associated with the 60 GHz P2P connection is exchanged when the first WFD session connection is completed.

12. The terminal according to claim 11, wherein:
the information associated with the 60 GHz P2P connection includes 60 GHz beamforming control information,
wherein the 60 GHz beamforming control information includes best sector ID (identifier) information.

13. The terminal according to claim 12, wherein:
the best sector ID information indicates a sector having the highest SNR (Signal to Noise Ratio) or the highest RSSI (Received Signal Strength Indicator) from among a plurality of sectors established at 60 GHz.

14. The terminal according to claim 11, wherein:
the first WFD session connection is completed based on an M8 request message and an M8 response message, and
the 60 GHz P2P connection associated information is contained in the M8 request message and the M8 response message, and is then exchanged.

15. The terminal according to claim 11, wherein the 60 GHz P2P connection associated information is cached to the terminal, before the first WFD session connection is completed.
